(19) United States
(12) Patent Application Publication
(10) Pub. No.: US 2011/0079592 A1
(43) Pub. Date: Apr. 7, 2011

(54) HIGH FREQUENCY HEATING DEVICE WITH HEATER

(75) Inventor: Toshiyuki Tsujimoto, Osaka (JP)

(73) Assignee: Panasonic Corporation, Kadoma-shi (JP)

(21) Appl. No.: 12/996,170

(22) PCT Filed: Jun. 1, 2009
(86) PCT No.: PCT/JP2009/002410

§ 371 Date: Dec. 3, 2010

(30) Foreign Application Priority Data
Jun. 5, 2008 (JP) 2008-14766

(51) Int. Cl. H05B 6/70

(52) U.S. Cl. 219/690

(57) ABSTRACT

A system for blowing heated air flows from behind a heating chamber has tended to induce non-uniform burning of cooked foods and has involved long cooking times. There is provided a structure including upper blow-off ports, lower blow-off ports and blow-in ports which are placed in side surfaces of a heating chamber in left and right sides of the heating chamber, in order to circulate heat within the heating chamber, which realizes a system for heating through circulations of heated air flows from left and right sides of the heating chamber, thereby enabling reduction of cooking times.

### TECHNICAL FIELD

The present invention relates to a heating device which heats objects to be heated using heaters and microwaves.

### BACKGROUND ART

A conventional high frequency heating device with heater includes blow-off holes and inhalation holes for heated air flows in a back surface of a heating chamber and, further, includes a case provided behind the back surface. Within the case, there is a blade for circulating heated air flows. A heater is secured near the blade, which provides a structure for blowing heated air flows into the heating chamber through rotation of the blade.

FIG. 6 is a cross-sectional view illustrating a conventional high frequency heating device with heater, at a side surface thereof. As illustrated in FIG. 6, circulation fan case 33 is secured to back surface 32 of heating chamber 31 therebehind. Further, circulation fan 34, heater 35 and circulation fan motor 36 are supported by and secured to circulation fan case 33. Through rotations of circulation fan motor 36 and circulation fan 34, heat is inhaled through the center of circulation fan 34. Inhaled heat 37 is blown in directions of upper blown air flow 38 and lower blown air flow 39 from upper and lower opening holes (not illustrated) in back surface 32 of heating chamber 31. Further, the air blown therefrom is transferred to a front side of heating chamber 31 and is circulated therein, again. With this structure, there is provided a heating device with heater having a common heating system for causing heated air flows to surround food 40 at the center of heating chamber 31 (refer to Patent Literature 1, for example).

However, the conventional structure employs such a system for blowing heated air flows from behind the heating chamber, which has tended to induce non-uniform burning of cooked foods and also has involved long cooking times.

### Patent Literature

### [PTL 1] Unexamined Japanese Patent Publication No. 9-159186

### SUMMARY OF THE INVENTION

According to the present invention, there is provided a structure including a waveguide for supplying a microwave, an antenna connected to the waveguide, a heating chamber for storing foods therein, a net for placing a food thereon in the heating chamber, and circulation fan cases, one being provided on a left side of an outer side of the heating chamber and the other one being provided on a right side of the outer side of the heating chamber, wherein each of the circulation fan cases includes, inside thereof, a circulation fan and a heater in a path of an air flow induced by driving the circulation fan.

Thus, heated air flows are circulated from left and right sides within narrow spaces, which enables cooking foods rapidly and uniformly.

### BRIEF DESCRIPTION OF THE DRAWINGS

FIG. 1 is a cross-sectional view illustrating a high frequency heating device with heater according to a first embodiment of the present invention, at a side surface thereof.

FIG. 2 is a cross-sectional view illustrating the high frequency heating device with heater according to the first embodiment of the present invention, at its front surface.

FIG. 3 is a cross-sectional view illustrating a high frequency heating device with heater according to a second embodiment of the present invention, at a side surface thereof.

FIG. 4 is a cross-sectional view illustrating the high frequency heating device with heater according to the second embodiment of the present invention, at its front surface.

FIG. 5 is a cross-sectional view illustrating a high frequency heating device with heater according to a third embodiment of the present invention, at a front surface thereof.

FIG. 6 is a cross-sectional view illustrating a conventional high frequency heating device with heater, at a side surface thereof.

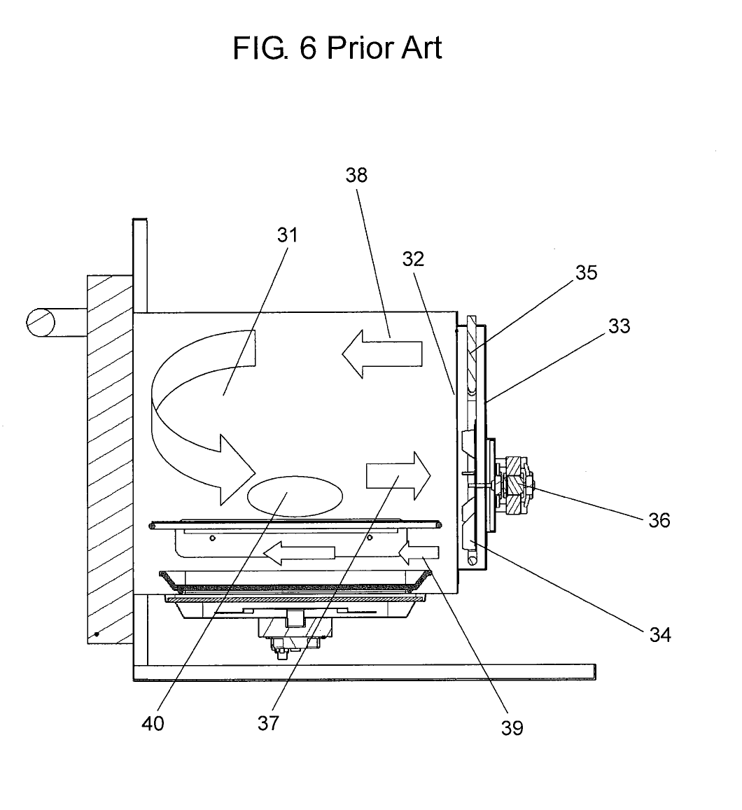

### DETAILED DESCRIPTION OF THE PREFERRED EMBODIMENTS

### First Embodiment

Hereinafter, an embodiment of the present invention will be described with reference to the drawings. Further, this embodiment is not intended to limited the present invention.

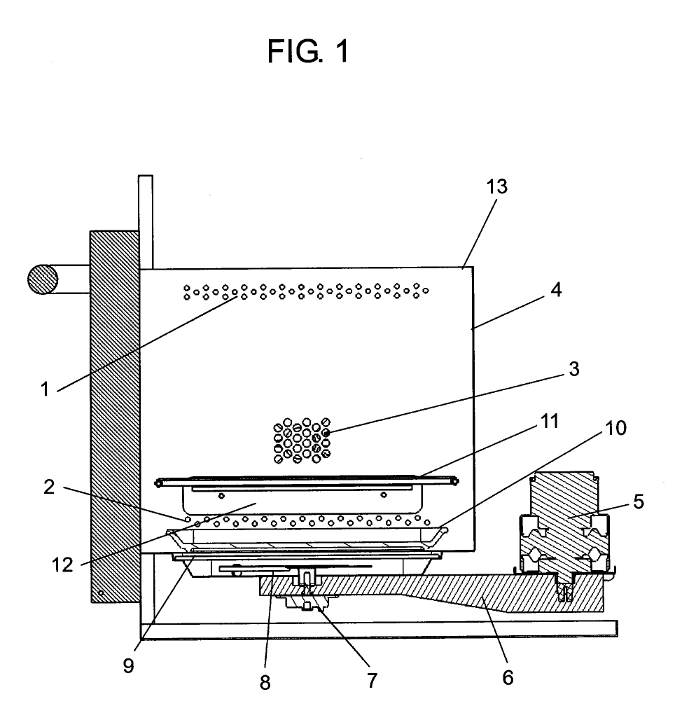

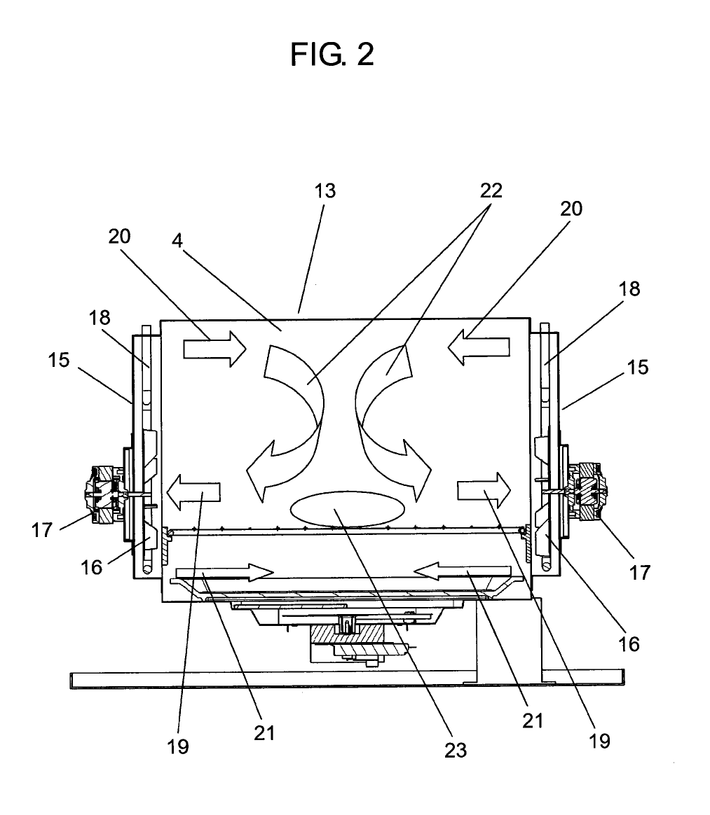

FIG. 1 and FIG. 2 are views illustrating a high frequency heating device with heater according to a first embodiment. FIG. 1 is a cross-sectional view illustrating the same at a side surface thereof. FIG. 2 is a cross-sectional view illustrating the same at its front surface.

As illustrated in FIG. 1, magnetron 5 is placed outside of heating chamber 4. Under heating chamber 4, there is secured, thereto, waveguide 6 which transfers microwaves from magnetron 5 to the center of the lower portion of heating chamber 4. Motor 7 is provided on an outer side of waveguide 6, at the center of the lower portion of heating chamber 4. Antenna 8 is provided within a space at the center of the lower portion of heating chamber 4 and above waveguide 6 and is driven by motor 7. The space which houses antenna 8 therein is closed and sealed by ceramic plate 9, in order to prevent intrusion of contaminations thereinto.

Within heating chamber 4, table 10 which receives contaminations of foods is provided on ceramic plate 9. Rails 12 are provided on left and right inner side surfaces of heating chamber 4, and net 11 for placing foods thereon is supported by rails 12, such that net 11 can be inserted therein and pulled out therefrom. In the left and right inner side surfaces of heating chamber 4, there are provided upper blow-off ports 1 at upper portions of the side surfaces, lower blow-off ports 2 at lower portions of the side surfaces, and blow-in ports 3 at center portions of the side surfaces. Further, circulation fan cases 15 are provided outside of upper blow-off ports 1, lower blow-off ports 2 and blow-in ports 3, and heating chamber 4 is communicated with the insides of circulation fan cases 15 through upper blow-off ports 1, lower blow-off ports 2 and blow-in ports 3. Each of circulation fan cases 15 includes circulation motor 17 on the outer side thereof and, further, include, inside thereof, circulation fan 16 connected to circulation motor 17. Heater 18 is provided above circulation fan 16. Circulation fan 16 is placed at a portion at which the center portion of circulation fan 16 corresponds to blow-in ports 3. Further, heater 18 is provided at a portion at which it corresponds to upper blow-off ports 1, within circulation fan case 15.

Hereinafter, a description will be given of operations and effects of the high frequency heating device with heater having the aforementioned structure.

In cases of heating with microwaves, when magnetron 5 is driven, it generates microwaves. When motor 7 is driven, antenna 8 is rotated thereby to supply radio waves to heating chamber 4. As a result thereof, food 23 is heated by microwaves. In the present embodiment, antenna 8 and waveguide 6 for supplying microwaves are placed near the bottom surface of heating chamber 4, and heaters 18 are provided at the opposite sides of heating chamber 4, which prevents heaters 18 from obstructing heating with microwaves.

Further, in cases of heating with the heaters, heaters 18 are turned on and, concurrently, circulation motors 17 are driven. By the rotation of circulation fans 16, heat 19 is inhaled through blow-in ports 3 and, then, is blown into heating chamber 4 from upper blow-off ports 1 and lower blow-off ports 2. These heated air flows become upper blown air flows 20 and lower blown air flows 21 and flow in directions of center arrows 22 of heating chamber 4. The heated air flows impinge on food 23 to heat food 23. Thereafter, the heated air flows are inhaled through blow-in ports 3, again. Thus, air within heating chamber 4 is heated by heaters 18 and is circulated inside and outside of heating chamber 4 by circulation fans 16 (hereinafter, this operation will be referred to as a heated-air-flow circulation). As illustrated in FIG. 2, through this heated-air-flow circulation, food 23 placed on net 11 can be immediately and uniformly heated by heated air flows which are blown from the left and right sides of heating chamber 4 and circulated therein, as illustrated by center arrows 22.

Further, in a case where it is desired to rapidly perform heating processing on foods, it is possible to perform cooking using microwaves and cooking using the heaters, concurrently. In cases of performing such concurrent heating using both microwaves and the heaters, it is possible to perform heating in three directions from both the side surfaces and from the lower side, which enables efficiently performing heating cooking on foods. Further, while, in the present embodiment, there has been exemplified a case where each of heaters 18 is provided at the portion at which it corresponds to upper blow-off ports 1, the position at which heater 18 is provided is not limited thereto, and heater 18 can be placed at any portion at which it corresponds to heated-air-flow circulation path, which can also offer the same effects. Further, while there has been exemplified a case where each of circulation fans 16 is provided at the portion at which the center portion of circulation fan 16 corresponds to blow-in ports 3 within circulation fan case 15, the position at which circulation fan 16 is provided is not limited thereto and can be any position which can create circulations for causing heated air flows to impinge on food 23, which can also offer the same effects.

### Second Embodiment

In the present embodiment, the same parts as those in the first embodiment will not be described, and only different parts therefrom will be described.

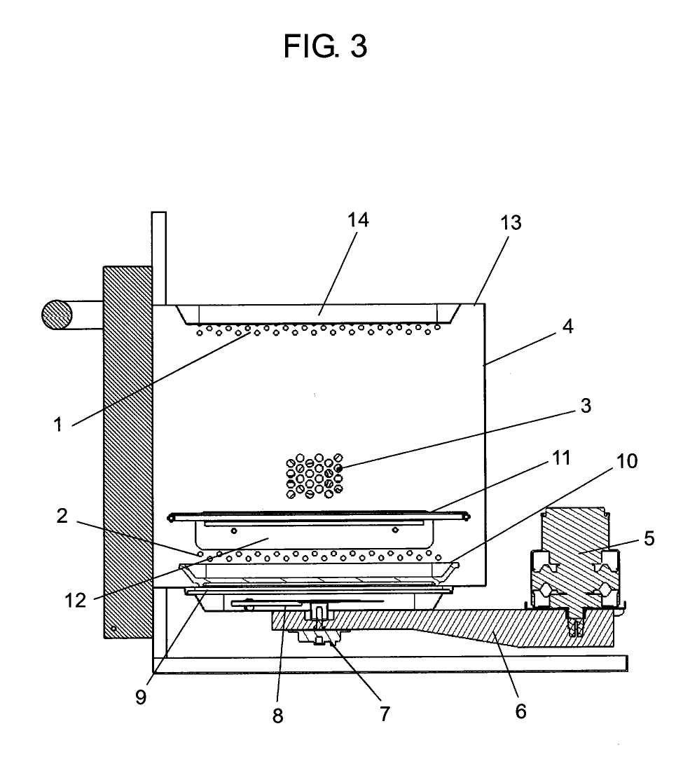

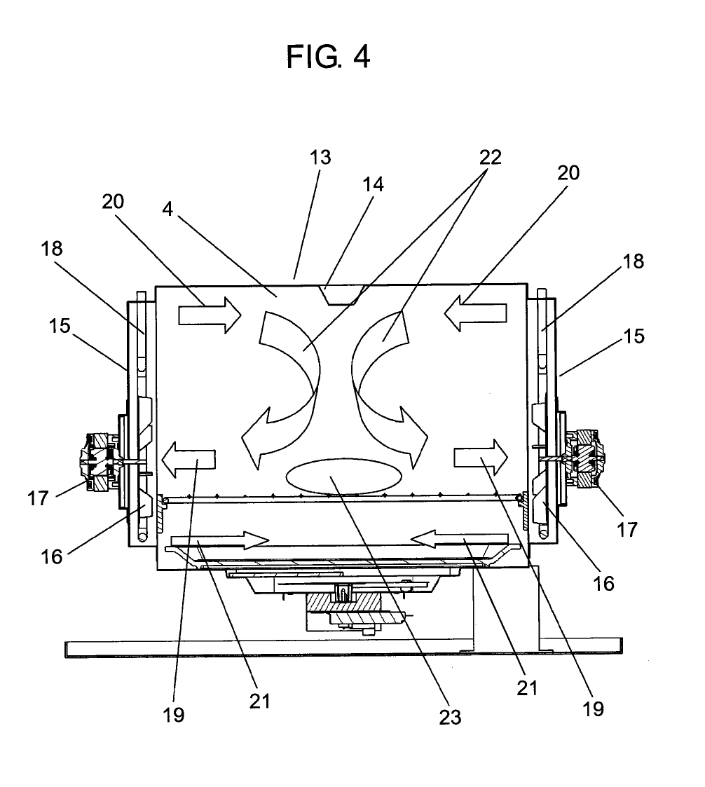

FIG. 3 and FIG. 4 are views illustrating a high frequency heating device with heater according to the present embodiment. In the present embodiment, in addition to the first embodiment, rib-shaped protrusion 14 is provided in the depth direction at the center portion of ceiling 13 of heating chamber 4. Accordingly, heated air flows blown out of the upper and lower blow-off ports in the left and right wall surfaces of heating chamber 4 are directed toward food 23, by rib-shaped protrusion 14 which partitions ceiling 13 of heating chamber 4 at the center thereof. Thus, heated air flows from left and right sides of heating chamber 4 are circulated within narrow spaces bounded by the center of heating chamber 4 and, then, impinge on the food placed on net 11. As a result thereof, food 23 can be effectively heated. Further, while rib-shaped protrusion 14 has been illustrated in the present embodiment, it is also possible to employ any protrusion which can cause smooth circulations of heated air flows as upper blown air flows 20, such as a V-shaped protrusion.

### Third Embodiment

In the present embodiment, the same parts as those in the first embodiment will not be described, and only different parts therefrom will be described.

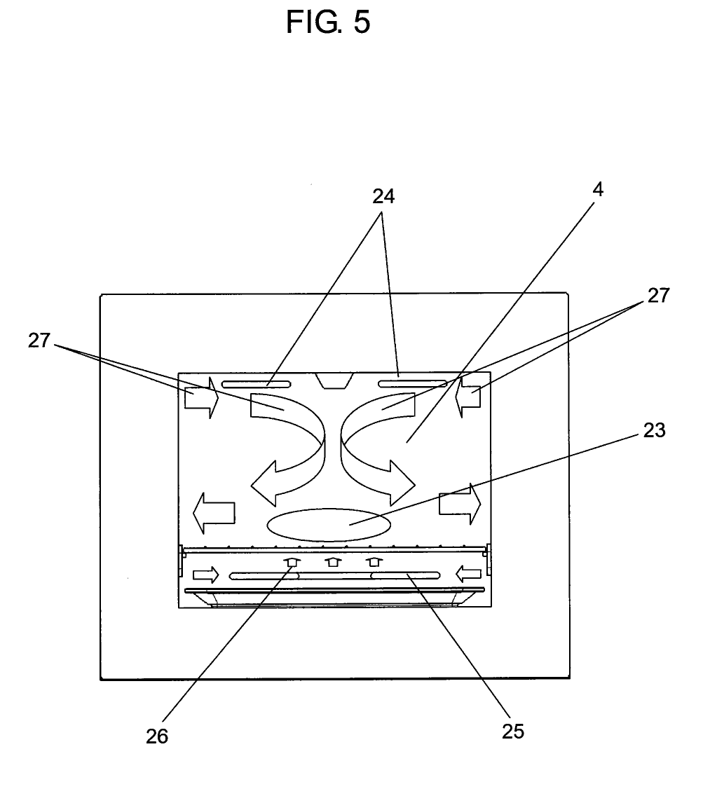

FIG. 5 is a view illustrating a high frequency heating device with heater according to a third embodiment.

In the present embodiment, as illustrated in FIG. 5, upper heaters 24 and lower heater 25 are placed within heating chamber 4. Upper heaters 24 are placed at positions to which circulated air flows 27 are blown, on a back surface of heating chamber 4 and above the position at which food 23 is placed. Further, lower heater 25 is placed at a position to which circulated air flows 27 are blown, below the position at which food 23 is placed, within heating chamber 4. Since upper heaters 24 and lower heater 25 are provided in the heated-air-flow circulation paths, circulated air flows 27 take heat from upper heaters 24 and lower heater 25, which causes heated air flows to effectively surround food 23 in its entirety. Further, since lower heater 25 is provided inside heating chamber 4, food 23 can be directly heated, at its lower surface, by radiation heat 26 therefrom, which enables cooking food 23 at a higher speed. Further, while in the present embodiment, there has been illustrated a case where upper heaters 24 and lower heater 25 are provided in the heated-air-flow circulation paths, it is also possible to select any one of these heaters.

### INDUSTRIAL APPLICABILITY

As described above, the present invention can be applied to a high frequency heating device with heater and enables high-speed and uniform cooking through circulations of heated air flows from left and right sides of the heating chamber.

### Reference Marks in the Drawings

1 Upper blow-off port

2 Lower blow-off port

3 Blow-in port

4 Heating chamber

6 Waveguide

8 Antenna

14 Protrusion

24 Upper heater

25 Lower heater

1. A high frequency heating device with heater, comprising:
a waveguide for supplying a microwave;
an antenna connected to the waveguide;
a heating chamber for storing a food;
a net which is provided within the heating chamber and adapted to place a food thereon;
two circulation fan cases, one being provided on a left side of an outer side of the heating chamber and the other one being provided on a right side of the outer side of the heating chamber;
a circulation fan provided inside each of the circulation fan cases; and
a heater provided in a path of an air flow induced by driving the circulation fan.

2. The high frequency heating device with heater according to claim 1, wherein
the waveguide and the antenna are placed on a bottom portion of the heating chamber.

3. The high frequency heating device with heater according to claim 1, further comprising
a rib-shaped protrusion provided on a ceiling of the heating chamber.
